(19) United States
(12) Patent Application Publication
(10) Pub. No.: US 2016/0048841 A1
(43) Pub. Date: Feb. 18, 2016

(54) SEAMLESS CUSTOMER TRANSFER IN A VIDEO CONFERENCING SYSTEM

(71) Applicant: Bank of America Corporation, Charlotte, NC (US)

(72) Inventors: Tyler Johnson, Tega City, SC (US); James Robert Grimsley, Dover, FL (US); Nathan Dent, Concord, NC (US); Sara Gill, New York, NY (US); Christian Michael Mande, Charlotte, NC (US); Kristy M. Crist, Charlotte, NC (US)

(21) Appl. No.: 14/461,125

(22) Filed: Aug. 15, 2014

(51) Int. Cl. G06Q 30/00; H04N 7/15

(52) U.S. Cl. CPC G06Q 30/01; H04N 7/15

(57) ABSTRACT

Systems, apparatus, and computer program products are provided for seamlessly transferring customers from one specialist to another specialist during an ongoing video conferencing communication session. In specific embodiments of the invention, simultaneous communication is provided amongst the customer, the transferor (or first) specialist and the transferee (or second) specialist, prior to the first specialist departing the communication session. In one specific embodiment, simultaneous communication provides for dual screen display, in which the customer views and communicates with both specialists simultaneously, while the specialists view and communicate with the customer and the other specialist. In additional embodiments of the invention, in which information pertaining to the customer may have privacy concerns, customer information exchange rules are implemented to automatically determine which information accessible to the first specialist can be communicated to the second specialist prior to the seamless transition.

### FIELD

In general, embodiments of the invention relate to communication services and, more particularly, providing a seamless transfer of a customer from one specialist to another specialist in a video conferencing system.

### BACKGROUND

Customers of businesses, such as financial institutions or the like, that have many customer service outlets, otherwise referred to as centers, branches or the like, have come to expect that when they visit any of the service outlets, the service outlet will have the immediate capability to address their particular special needs or services. However, as businesses such as financial institutions streamline their operations for the sake of efficiency, they have come to realize that round-the-clock location of specialists at each service outlet/center is inefficient. For example, in the financial institution setting, if each banking center employs at least one full-time mortgage/loan specialist, a full-time small business specialist and/or a full-time personal financial advisor/specialist, the specialist may only be called upon in regards to their specialty in the event a customer visits the banking center requiring assistance in the area of specialty.

Certain businesses, such as financial institutions and the like, have addressed the problem associated with staffing service outlets with full-time specialists by implementing video conferencing systems. Specifically, such video conferencing systems may employ two-way video conferencing communication between a customer, who is located at the service outlet/banking center, and a specialist, who is located remote from the service outlet/banking center, such that both customer and specialist receive audio and video feeds of the other participant. Alternatively, a one-way video conferencing system provides the customer a video and audio feed of a remote specialist, while the remote specialist is limited to receiving an audio feed from the customer. Such video conferencing systems are set-up in private settings within the business to provide the customer assurance that the information exchanged during the communication session is held in private. In this regard, a customer service outlet/center equipped with video conferencing communication can provide customers on-demand access to specialists having different areas of specialty/expertise without requiring the full-time physical presence of the specialist at the business outlet/center.

In certain instances, it becomes apparent that a customer that is participating in a video conferencing communication session or any other media-based communication requires further assistance, such as from another specialist, either another specialist of the same specialty or another specialist of a different specialty (i.e., a different line-of-business or the like). Additionally, the further assistance that may be required may be some form of self-service assistance, in which the customer need not rely on communication with another business associate or specialist. In such instances, the further assistance may require the customer to transfer from one communication source to another source (e.g., from a video communication mechanism to a tablet device, personal computer device or the like.)

Currently, in the video conferencing environment the options for transferring/transitioning the customer are rather limited; either the specialist that is communicating with the customer can provide the customer a referral (i.e., provide the name of a an associate/specialist who may or may not be located at the banking center where the customer is currently located), or the specialist can instruct the customer to exit the current video conference communication session and, subsequently re-dial or initiate a new video conference communication session with the other specialist. However, both options result in ineffective customer service. Both the referral process and the initiation of a new video conference communication session create undesirable time delay and efficiencies in the communication between the customer and the business. Such time delay is not only burdensome to the customer but, from the business perspective, also poses a serious threat to lost business opportunities. From the inefficiency perspective, since both the referral process and the initiation of a new video conference communication session result in a communication disconnect, any information shared with the initial specialist, private or otherwise, is not readily susceptible to being shared or otherwise available to the subsequent specialist.

Moreover, when transferring a customer between specialists or amongst different communication platforms the business may want to insure that the customer's needs are met and/or that the cost-effective source of communication is used upon transfer.

Therefore, a need exists to develop systems, apparatus, methods, computer program products and the like that provide for assisting in the seamless transfer of a customer from one specialist to another specialist in a video conferencing environment. The desired aspects should alleviate problems related to disconnects and/or time delays associated with a customer requiring communication with another specialist. In addition, the desired systems, apparatus, methods, computer program products and the like should allow for customer information, private or otherwise, to be readily shared amongst specialists so as to eliminate the need of the customer to communicate information to a subsequent specialist that was previously communicated to the first specialist. Moreover, the desired aspects should address the need to determine, and provide, the level of service required by the customer when communicating with the subsequent specialist, so as to meet the expectations of the customer while balancing cost effectiveness on behalf of the business.

### SUMMARY OF THE INVENTION

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing apparatus, computer program products or the like for seamlessly transferring customers from one specialist to another specialist during an ongoing video conference communication session conducted at a customer service outlet, such as a banking center or the like. In specific embodiments of the invention, simultaneous communication is provided amongst the customer, the transferor (or first) specialist and the transferee (or second) specialist, prior to the first specialist departing the communication session. In one specific embodiment, simultaneous communication provides for dual screen display, in which the customer views and communicates with both specialists simultaneously, while the specialists view and communicate with the customer and the other specialist. In additional embodiments of the invention, in which information pertaining to the customer may have privacy concerns, customer information exchange rules are implemented to automatically determine which information accessible to the first specialist can be communicated to the second specialist. Thus, the seamless transfer between specialists eliminates the need for and the delays associated with separate video conference communication sessions.

A system for seamlessly transferring a customer between specialists in a video conferencing environment defines first embodiments of the invention. The system includes a video conferencing apparatus located within a private setting in a business location and including a computing platform having a display, a video camera, a speaker, and a microphone, all in communication with a processor device. The video conferencing apparatus is configured to implement a plurality of the display, the video camera, the speaker and the microphone to provide a customer a communication platform for conducting a video conference communication session with a specialist located remote from the business location.

The system further includes a customer transferring module stored in a memory and executable by a processor. In response to (1) receiving, during a video conference communication session conducted between a customer and a first specialist, an indication that the customer requires communication with a second specialist, and (2) communicating, to the second specialist, information related to the customer, the module is configured to transition the video conference communication session between the customer and the first specialist to a transition mode that allows the customer, the first specialist and the second specialist to communicate simultaneously prior to the first specialist exiting the video conference communication session.

In specific embodiments of the system, the customer transferring module further includes a customer information exchange rules engine that is configured to apply business rules to determine the information related to the customer that is approved to be communicated from the first specialist to the second specialist. In such embodiments of the system, the customer information exchange rules engine is further configured to apply customer information exchange business rules to determine the information related to the customer that is approved to be communicated based on at least one of (1) information related to the customer accessible to the first specialist and (2) a type of the second specialist.

In further specific embodiments of the system, the customer transferring module is further configured to (1) present the customer, via a video conferencing apparatus, an information exchange option and, in response to receiving a customer input that selects the information exchange option, (2) electronically communicate, to the second specialist, the information related to the customer.

In further specific embodiments of the system, the customer transferring module is further configured to present, in the transition mode, a dual screen display of a first video stream of the first specialist and a second video stream or image of the second specialist (e.g., the image of the second specialist may be presented when the customer is transitioning from a video conference with the first specialist to an audio-only or text chat communication with the second specialist). In such embodiments of the system, once the first specialist has handed-off the video conference communication session to the second specialist, the first video stream will no longer be displayed.

In still further specific embodiments of the system, the customer transferring module is further configured to transition the video conference communication session between the customer and the first specialist to the transition mode, wherein the transition mode allows the customer, the first specialist and the second specialist to communicate using one or more communication media chosen from (1) video and audio, (2) audio-only or (3) text chat.

In still further embodiments of the system, the customer transferring module is further configured to determine the one or more communication media for the customer to use to communicate with the second specialist based on at least one of (1) business rules, and (2) media capabilities of the second specialist.

In yet other specific embodiments of the system, the first specialist is associated with a first line-of-business and the second specialist is associated with a second line-of-business different from the first line-of-business. For example, in the financial institution setting, the first and second lines-of-business may be one of mortgage/loan, wealth/financial advisor, or small business.

A method for transferring a customer between specialists in a video conferencing environment defines second embodiments of the invention. The method includes, in response to receiving, during a video conference communication session conducted between a customer and a first specialist, an indication that the customer requires communication with a second specialist, electronically communicating to the second specialist, information related to the customer. The method further includes seamlessly transitioning the video conference communication session from communication between the customer and the first specialist to a transition mode that allows the customer, the first specialist and the second specialist to communicate simultaneously prior to the first specialist exiting the video conference communication session.

In specific embodiments the method may further include applying business rules to determine the information related to the customer that is approved to be communicated from the first specialist to the second specialist. In such embodiments of the method, the business rules may be based on at least one of (1) information related to the customer accessible to the first specialist, and (2) a type of the second specialist.

In other specific embodiments the method may include presenting to the customer, via a video conferencing apparatus, an information exchange option, and, in response to receiving a customer input that selects the information exchange option, electronically communicating, to the second specialist, the information related to the customer.

In further specific embodiments of the method, transitioning further comprises includes presenting, in the transition mode, a dual screen display of a first video stream of the first specialist and a second video stream or image of the second specialist (e.g., the image of the second specialist may be presented when the customer is transitioning from a video conference with the first specialist to an audio-only or text chat communication with the second specialist). In related embodiments of the method, the transition mode allows the customer, the first specialist and the second specialist to communicate using one or more communication media chosen from (1) audio, (2) video and/or (3) text chat.

A computer program product including a non-transitory computer-readable medium defines third embodiments of the invention. The computer-readable medium includes a first set of codes for causing a computer to, in response to receiving, during a video conference communication session conducted between a customer, located at a place of business, and a first specialist, an indication that the customer requires communication with a second specialist, electronically communicate, to the second specialist, information related to the customer. The computer-readable medium additionally includes a second set of codes for causing a computer to seamlessly transition the video conference communication session from communication between the customer and the first specialist to a transition mode that allows the customer, the first specialist and the second specialist to communicate simultaneously prior to the first specialist exiting the video conference communication session.

Thus, systems, apparatus, methods, and computer program products herein described in detail below provide for seamlessly transferring customers from one specialist to another specialist during an ongoing video conference communication session conducted at a customer service outlet, such as a banking center or the like. In specific embodiments of the invention, simultaneous communication is provided amongst the customer, the transferor (or first) specialist and the transferee (or second) specialist, prior to the first specialist departing the communication session. In one specific embodiment, simultaneous communication provides for dual screen display, in which the customer views and communicates with both specialists simultaneously, while the specialists view and communicate with the customer and the other specialist. In additional embodiments of the invention, in which information pertaining to the customer may have privacy concerns, customer information exchange rules are implemented to automatically determine which information accessible to the first specialist can be communicated to the second specialist. Thus, the seamless transfer between specialists eliminates the need for and the delays associated with separate video conference communication sessions.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 provides a schematic and block diagram of a system configured for seamless customer transfer from one video conference specialist to another video conference specialist, in accordance with embodiments of the present invention;

FIG. 2 provides a block diagram of a video conferencing apparatus configured for seamless customer transfer, in accordance with embodiments of the present invention;

FIG. 3 provides a more detailed block diagram of a video conferencing apparatus configured for seamless customer transfer, in accordance with present embodiments of the invention;

FIG. 4 provides a block diagram of an apparatus configured for media format determination when transferring a customer from one specialist to another specialist, in accordance with embodiments of the present invention;

FIG. 5 provides a more detailed block diagram of an apparatus configured for media format determination when transferring a customer from one specialist to another specialist, in accordance with embodiments of the present invention;

FIG. 6 provides a flow diagram of a method for seamless customer transfer from one specialist to another specialist during an ongoing video communication session, in accordance with embodiments of the present invention;

FIG. 7 provides a flow diagram of a method for media format determination when transferring a customer from one specialist to another specialist, in accordance with embodiments of the present invention;

FIG. 8 is an exemplary process flow illustrating a process for a adding a third party to a line of communication between a first user and a second user via a video conference system, in accordance with embodiments of the present invention;

FIG. 9 is an exemplary user-interface for authenticating a third party, in accordance with embodiments of the invention; and

FIG. 10 is an exemplary system diagram configured for a adding a third party to a line of communication between a first user and a second user via a video conference system; in accordance with embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Although some embodiments of the invention described herein are generally described as involving a “financial institution,” one of ordinary skill in the art will appreciate that the invention may be utilized by other businesses that take the place of or work in conjunction with financial institutions to perform one or more of the processes or steps described herein as being performed by a financial institution.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Perl, Smalltalk, C++ or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

### Seamless Customer Transfer in a Video Conference System

According to embodiments of the invention described herein, various systems, apparatus, methods, and computer program products are herein described for seamlessly transferring customers from one service specialist to another service specialist during an ongoing video conference communication session. In specific embodiments of the invention, simultaneous communication is provided amongst the customer, the transferor (or first) specialist and the transferee (or second) specialist, prior to the first specialist departing the communication session. In one specific embodiment, simultaneous communication provides for dual screen display, in which the customer views and communicates with both specialists simultaneously, while the specialists view and communicate with the customer and the other specialist. In additional embodiments of the invention, in which information pertaining to the customer may have privacy concerns, customer information exchange rules are implemented to automatically determine which information accessible to the first specialist can be communicated to the second specialist. Thus, the seamless transfer between specialists eliminates the need and the delays associated with separate video conference communication sessions.

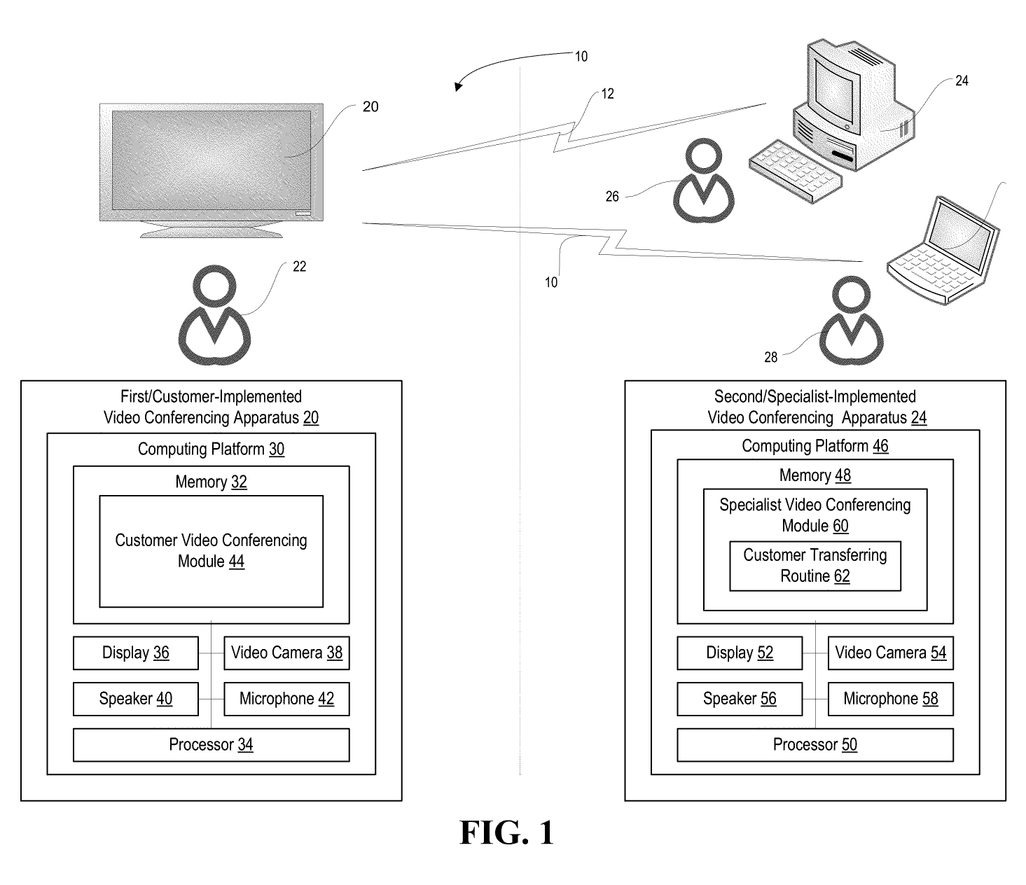

Referring to FIG. 1, a combination schematic and block diagram is presented of a system 10 for seamless customer transfer from one video conference specialist to another video conference specialist during an ongoing video conference communication session, in accordance with an embodiment of the invention. The system 10 includes a first or customer-implemented video conferencing apparatus 20 that is located within a private setting in a business location, such that the customer 22 can communicate and exchange private information with a specialist through designated communication devices. In one specific example, the first video conference apparatus 20 may be located within an enclosed space at a financial institution, such as a banking center. The customer-implemented video conferencing apparatus 20 includes a computing platform 30 having a memory 32 and a processor 34 in communication with memory 32. In addition, first video conferencing apparatus 20 includes a display 36, a video camera 38, a speaker 40 and a microphone 42, all of which are in communication with the processor 34 and may be embodied in hardware and/or software. The video conferencing apparatus 20 may include more than one device, such as dedicated, stationary video conferencing devices or the video conferencing apparatus 20 may be a single device, such as a mobile device (i.e., computing tablet or the like). The memory 32 of video conferencing apparatus 20 stores customer video conferencing module 44 that is configured to implement the display 36, the video camera 38, the speaker 40 and the microphone 42 to conduct a video (and audio) communication session (i.e., a video chat session) with a specialist that is located physically remote from the business location at which the first/customer-implemented video conferencing apparatus 20 is located.

The first video-conferencing apparatus 20 is in network 12 communication (wired, wireless or a combination thereof) with a second or specialist-implemented video conferencing apparatus 24. Second video conferencing apparatus 24 may be any communication device that facilitates audio and video communication, such as personal computer (PC), laptop computer, mobile computing device (e.g., tablet device, mobile/cellular telephone) or the like. The specialist-implemented video conferencing apparatus 24 includes a computing platform 46 having a memory 48 and a processor 50 in communication with memory 48. In addition, second video conferencing apparatus 24 includes a display 52, a video camera 54, a speaker 56 and a microphone 58, all of which are in communication with the processor 50 and may be embodied in hardware and/or software. The memory 48 of second/specialist-implemented video conferencing apparatus 24 stores specialist video conferencing module 60 that is configured to implement the display 52, the video camera 54, the speaker 56 and the microphone 58 to conduct a video (and audio) communication session (i.e., a video chat session) with a customer 22 that is located at the first video conferencing apparatus 20.

In accordance with embodiments of the present invention, the specialist video conferencing module 60 includes a customer transferring routine 62 that is configured to provide the customer with seamless transfer between specialists during an ongoing video conference communication session. It should be noted that while the customer transferring routine 62 is shown and described as being embodied in the specialist video conferencing module 60 at least a portion of the customer transferring routine 62 may also be embodied in the customer video conferencing module 44 and/or stored/executed at a network-based server. In the illustrated example of FIG. 1, the customer 22 is participating in a two-way video conferencing communication session with a first specialist 26 and requires seamless transfer to a second specialist 28.

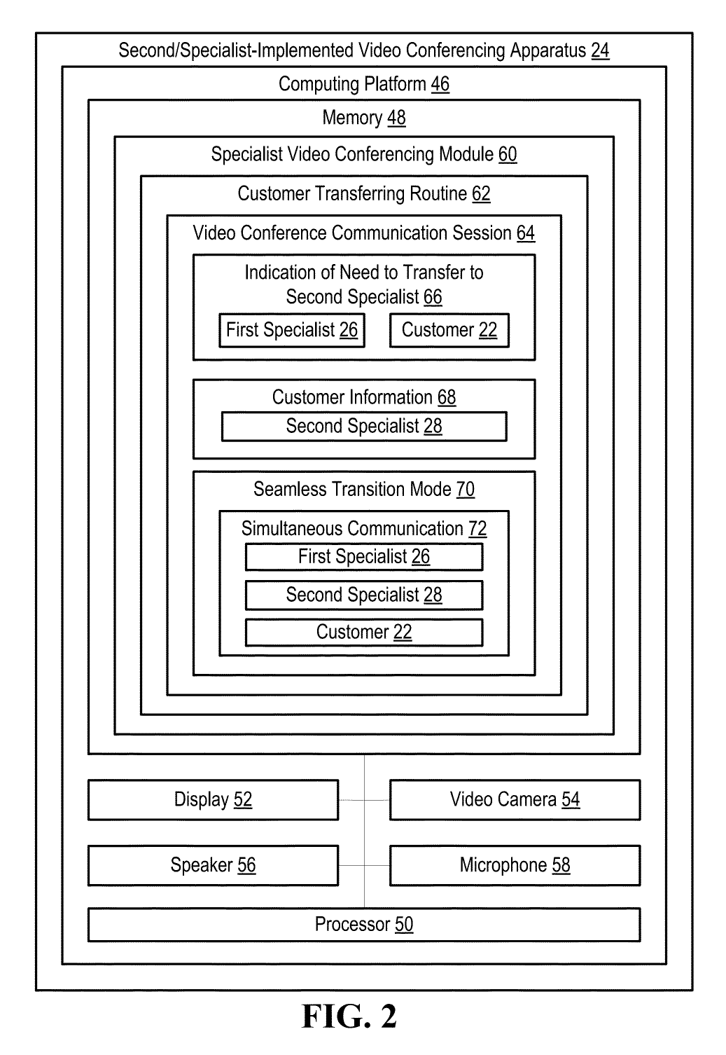

Referring to FIG. 2, a block diagram is presented of a second/specialist-implemented video conferencing apparatus 24 configured for seamless customer transfer from one specialist to another specialist during an ongoing video conference communication session, in accordance with embodiments of the present invention. As described in relation to FIG. 1, video conferencing apparatus 24 includes computing platform 46 having a memory 48 and a processor 50 in communication with memory 48. In addition, video conferencing apparatus 46 includes a display 52, a video camera 54, a speaker 56 and a microphone 58, all of which are in communication with the processor 50 and may be embodied in hardware and/or software. The memory 48 of video conferencing apparatus 24 stores specialist video conferencing module 60 that is configured to implement the display 52, the video camera 54, the speaker 56 and the microphone 58 to conduct a video conferencing communication session 64 (i.e., a video chat session) with a customer 22 that is located at the first video conferencing apparatus 20 (shown in FIG. 1). The specialist video conferencing module 60 includes a customer transferring routine 62 that is configured to provide the customer with seamless transfer between specialists during an ongoing video conferencing communication session 64.

In response to (1) receiving, during an ongoing video conferencing communication session 64 between a customer 22 and a first specialist 26, an indication of a need (or a request) to transfer 66 the customer to another specialist (i.e., one or more specialists, such as second specialist 28 or the like) and (2) communicating customer information 68 to the second specialist 28, the customer transferring module routine 62 is configured to provide a seamless transition mode 70 during the ongoing video conferencing communication session 64 that allows for simultaneous communication 72 between the customer 22, the first specialist 26 and the second specialist during the period in which the first specialist 26 hands-off the video conferencing communication session 64 to the second specialist 28 (i.e., the first specialist 26 drops-off of or departs from the video conferencing communication session 64).

The indication of a need to transfer 66 may be an input provided by either the first specialist 26 or the customer 22 and may include the type of specialist requested. For example, in a financial institution-based video conferencing system, a customer may be communicating with a mortgage/home loans specialist and during the course of the communication the specialist (or the customer) may perceive a need for the customer to communicate with a different type of specialist, (e.g., a financial advisor/wealth management advisor). The indication of the need to transfer 66 may result in identifying the second specialist 28, providing a listing of currently available second specialists 28 from which the first specialist 28 (or customer 22) may choose the appropriate second specialist 28 or trigger queuing of the second specialist 28 (such that the next available second specialist of the type requested is the transferee specialist for the ongoing video conferencing communication session 64). In specific embodiments, in which no specific second specialist 28 is selected or the selected second specialist 28 is immediate available, the customer 22 may by immediately presented the transition mode 70 without having to be placed in a queue or incur a waiting period. In such embodiments, the information 68 that is communicated to the second specialist 28 may occur in immediate response to receiving the indication that the customer requires communication with a second specialist.

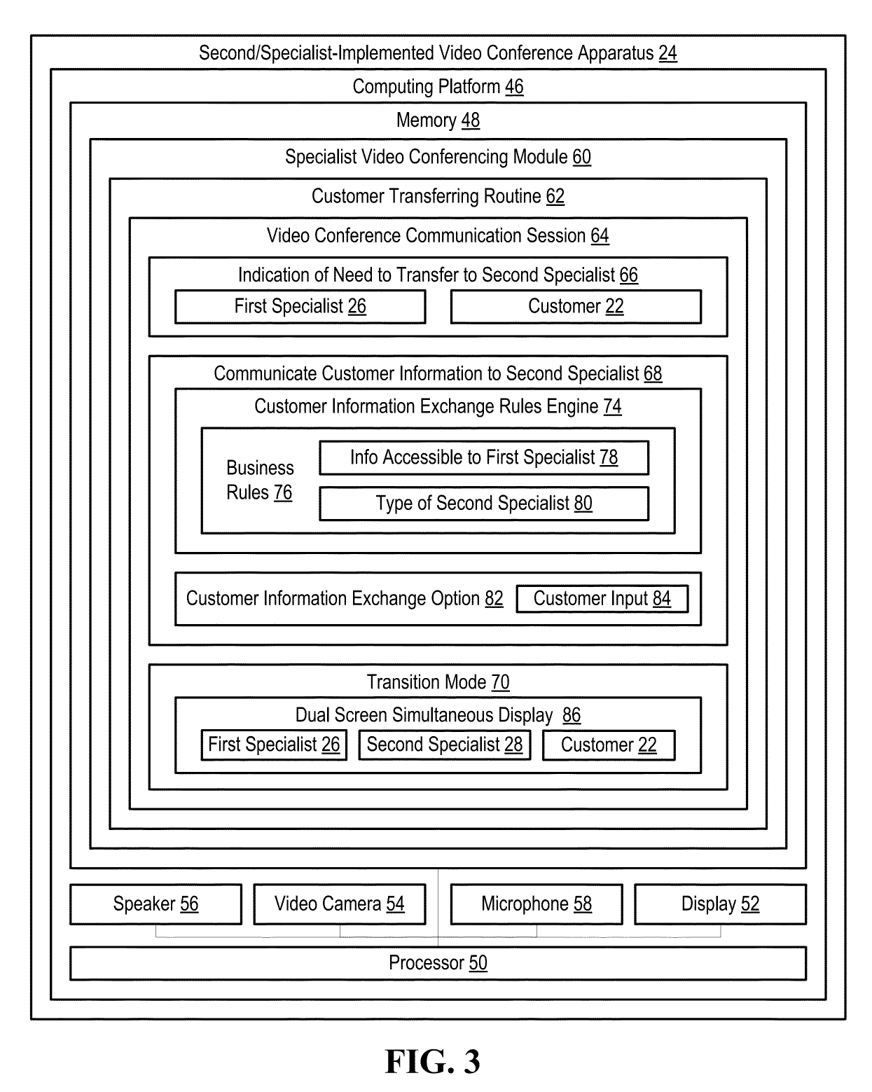

Communicating customer information 68 to the second specialist 28 prior to the seamless transition mode 70 may be necessary to insure more efficiency during the transition mode 70. The second specialist 28 can either review the customer information 68 prior to joining the transition mode 70 and/or rely on the customer information 68 during the transition mode 70 and thereafter. In specific embodiments, the customer information 68, which may be historical customer information stored in the customer's profile and/or may be dynamic information obtained by the first specialist 26 during the ongoing video conferencing communication session 64, may be communicated electronically or electronically accessible to the second specialist 28. In such embodiments, as described in more detail in relation to FIG. 3, in the event the second specialist 28 is of a type that can only receive, without explicit customer consent, specific information related to the customer, the customer transferring routine 62 may include a rules engine to determine what specific information can be communicated to the second specialist absent the explicit customer consent. In alternate embodiments of the invention, in which the first specialist 26 places the customer 22 on hold while contacting an appropriate second specialist 28, the first specialist 26 may, in addition to or in lieu of electronic communication, manually communicate the customer information 68 to the second specialist 28.

Moreover, the customer transferring routine 62 is configured to seamlessly transfer the video conferencing communication session 64 from (1) communication between first specialist 26 and the customer 22 to (2) to the transition mode 70 which includes simultaneous communication between the first specialist 26, the customer 22 and the second specialist 28. In embodiments in which the media format is video, simultaneous communication may include a dual screen display of two or more of the transition mode 70 participants. For example, the customer may be presented with a dual screen display of a live video stream of the first specialist and a live stream of the second specialist (or live video streams of multiple second specialists, if such is warranted), while the first specialist 26 is presented with dual screen display of a live video stream of the customer and a live video stream(s) of the other specialist(s). The transition mode 70 serves to create an environment for the first specialist 28 to introduce the customer 22 to the second specialist 28, as well as, a forum for the first specialist 26 to communicate the context of the transfer or other customer-related information to the second specialist 28 in the “presence” of the customer 22. In other embodiments in which the in which the media format is audio-only or text chat, simultaneous communication may include a video-stream display of the customer and the first specialist and a still image of the second specialist or information related to the second specialist (e.g., name or the like).

Referring to FIG. 3, a block diagram is presented of a second/specialist-implemented video conferencing apparatus 24 configured for seamless customer transfer from one specialist to another specialist during an ongoing video conferencing communication session, in accordance with embodiments of the present invention. The video conferencing apparatus 24 which may include more than one physical device or unit is operable to receive and execute modules, routines and applications, such as specialist video conferencing module 60 and the subcomponent customer transferring routine 62 and the like.

The video conferencing apparatus 24 includes a computing platform that can receive and execute routines and applications. The computing platform includes memory 48, which may comprise volatile and nonvolatile memory such as read-only and/or random-access memory (RAM and ROM), EPROM, EEPROM, flash cards, or any memory common to computer platforms. Further, memory 48 may include one or more flash memory cells, or may be any secondary or tertiary storage device, such as magnetic media, optical media, tape, or soft or hard disk.

Further, the computing platform also includes at least one processor 50, which may be an application-specific integrated circuit (“ASIC”), or other chipset, processor, logic circuit, or other data processing device. Processor 50 or other processor such as ASIC may execute an application programming interface (“API”) layer (not shown in FIG. 3) that interfaces with any resident programs, such as video conferencing module 60 and the subcomponent customer transferring routine 62 and the like, stored in the memory 48 of video conferencing apparatus 24. Processor 50 includes various processing subsystems (not shown in FIG. 3) embodied in hardware, firmware, software, and combinations thereof, that enable the functionality of video conferencing apparatus 24 and the operability of the apparatus on a network. For example, processing subsystems allow for initiating and maintaining communications, and exchanging data, with other networked devices. Additionally, processing subsystems may include any portion of the functionality of video conferencing module 60 obviating the need for such applications and modules to be stored in the memory.

As previously noted in relation to FIGS. 1 and 2, video conferencing apparatus 24 includes display 52, video camera/image capturing device 54, speaker 56 and microphone 58, which are all in communication with processor 50.

The memory 48 of video conferencing apparatus 24 stores specialist video conferencing module 60 that is configured to implement the display 52, the video camera 54, the speaker 56 and the microphone 58 to conduct a video conferencing communication session 64 (i.e., a video chat session) with a customer 22 that is located at a video conferencing apparatus (video conferencing apparatus 20 of FIG. 1). The specialist video conferencing module 60 includes a customer transferring routine 62 that is configured to provide the customer with seamless transfer between specialists during an ongoing video conferencing communication session 64.

In specific embodiments, the customer transferring routine 62 is configured to receive, during the ongoing video conferencing communication session 64 between the customer 22 and the first specialist 26, an indication of a need to transfer 66 the communication to a second specialist 66. It should be noted that a second specialist may include more than one specialist (e.g., different types of specialties) in those instances in which more than one specialist is needed or required by the customer. As previously noted the indication may comprise an input provided by either the first specialist 26 or the customer 22 and may include the type of specialist requested. In certain embodiments, the customer transfer routine 62 may be configured to allow the customer to initiate a transfer to another specialist of the same type in the event the customer 22 is experiencing communication problems (i.e., technical problems or the like) with the first specialist 26 or believes that they would be better serviced by another specialist. In other specific embodiments, the first specialist 26, through communications with the customer 22, may perceive the need for a different type of specialist and, in response to asking and confirming that the customer desires a transfer to another specialist at the conclusion of their discussions, provides the request input indicating the need for the transfer.

As previously discussed in relation to FIG. 2, the indication of the need to transfer 66 may result in any one of (a) identifying the second specialist 28, (b) providing a listing of currently available second specialist 28 from which the first specialist 28 (or customer 22) may choose the appropriate second specialist 28, (c) trigger queuing of the second specialist 28 (such that the next available specialist of the type requested is the transferee/second specialist 28 for the ongoing video conferencing communication session 64 and/or (d) immediate presentation of the transition mode in those instances in which the second specialist is immediately avialable. Queuing of the second specialist 28 may insure that the second specialist 28 is on-hand, waiting to join the transition mode 70 when the customer 22 and the first specialist 26 are ready to move into the transition mode 70. In other embodiments of the invention, the customer transferring routine 64 may be configured to alert the first specialist (and/or customer 22) when the second specialist has been identified and/or when the second specialist is ready to enter the transition mode 70. Identification of the second specialist is necessary in order to subsequently communicate customer information 68 to the second specialist 28 prior to the transition mode 70.

In addition, customer transferring routine 62 may be configured to electronically communicate customer information 68 to the second specialist 28 prior to the seamless transition mode 70. Such communication of customer information prior to the transition mode may be necessary to insure more efficiency during the transition mode 70 (i.e., the first specialist or the customer does not have to communicate rudimentary information and/or information communicated to the second specialist during the initial (pre-transition mode) portion of the video conferencing communication session 64). In this regard, the second specialist 28 can either review the customer information 68 prior to joining the transition mode 70 and/or rely on the customer information 68 during the transition mode 70 and thereafter. In specific embodiments, the customer information 68 may be historical customer information stored in the customer's profile and/or may be dynamic information obtained by the first specialist 26 during the ongoing video conferencing communication session 64.

The customer transferring routine 62 may be configured to include customer information exchange rules engine 74 that applies business rules 76 to determine what customer information 68 can (and cannot) be communicated to the second specialist 28, absent consent from the customer 22. The business rules 76 may be unique to different line-of-businesses or other entities within the business implementing the video conferencing system and may be based on the customer information 78 that is accessible or obtained by the first specialist 26 and/or the type 80 of the second specialist. For example, in the financial institution business setting, only certain information, as designated by privacy laws and/or the financial institution, may be communicated to a financial advisor/wealth management type specialist, absent consent by the customer. In this regard, the rules engine 74 acts as a filter to ensure that only compliant customer information is communicated to the second specialist prior to the transition mode 70. In other embodiments of the invention, the customer transferring routine 62 may be configured to include a customer information exchange option 82, which is presented to the customer 22 in response to receiving an indication 66 that a transfer is necessary and, which based on customer input 84 that acquiesces to the communication of the customer information 68, results in the communication of the customer information 68 to the second specialist 28. The customer information exchange option 82 may include all necessary disclosures which need to be communicated to the customer 22 for the purpose of effectuating the communication of the customer information 68 to the second specialist 28. It should be noted that in certain instances, all information pertaining to the customer (i.e., historical profile information or information obtained during the video conferencing communication session) may be communicated to the second specialist, without subjecting the information to the rules engine 74 or otherwise obtaining the customer's consent.

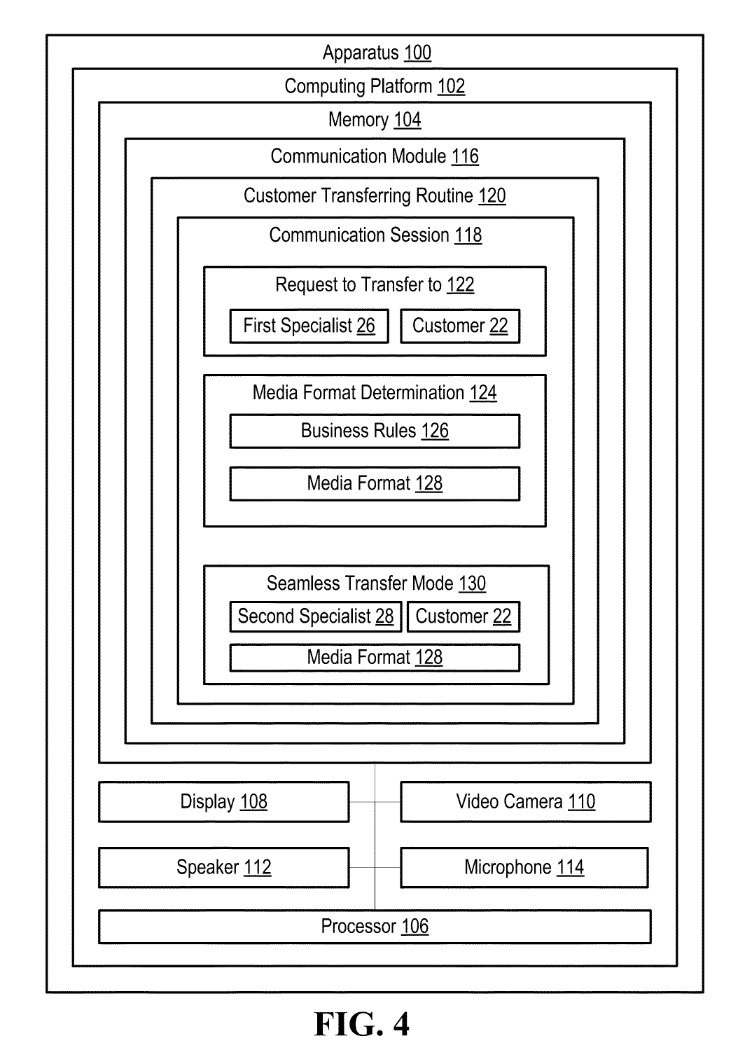

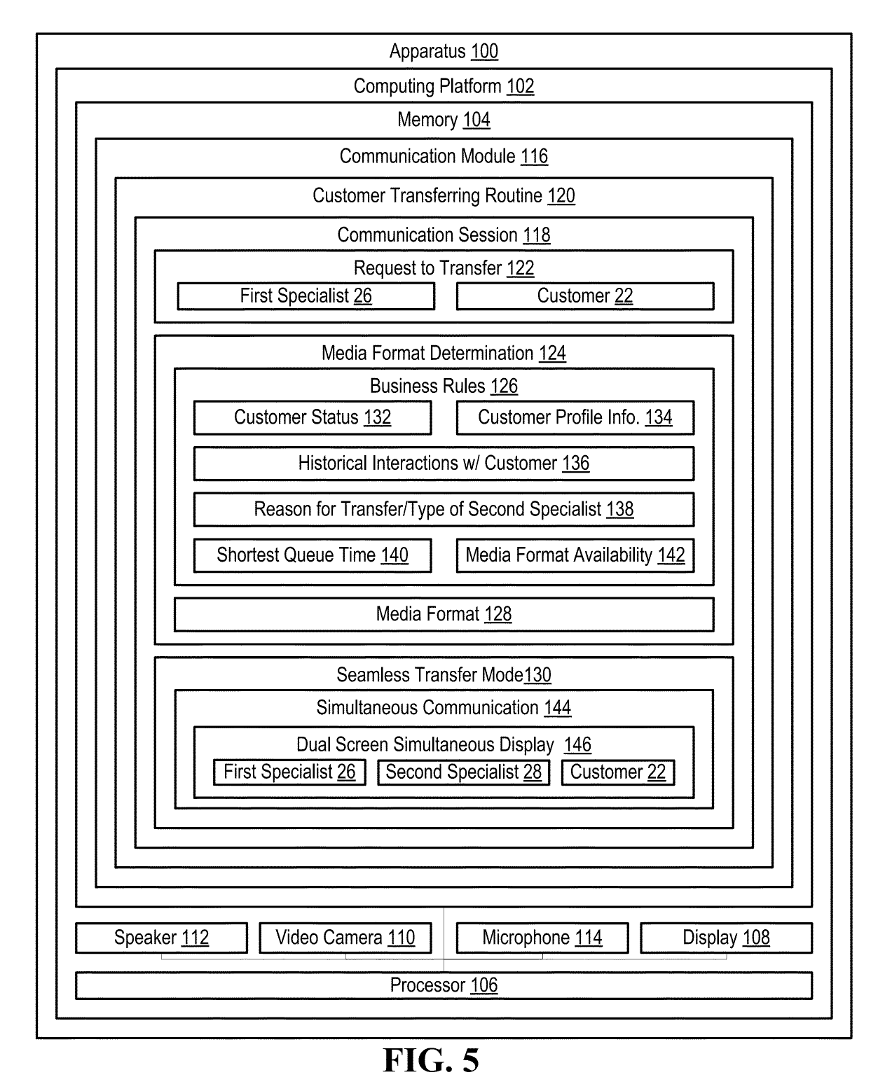

In alternate embodiments, not shown in FIG. 3 but described in detail in relation to FIGS. 4 and 5, the video conferencing module 60 may include an electronic media format determination routine configured to determine the electronic media format for the communication between the second specialist and the customer based on business rules and/or the media capabilities of the second specialist. In certain instances, the second specialist may only be capable of communicating via voice and/or text chat, while in other instances, the business, for economic reasons or the like, may prefer to implement voice-only conferencing or text chat (as opposed to video communication).

As previously noted in relation to FIG. 2, the customer transferring routine 62 is configured to seamlessly transfer the video conferencing communication session from (1) communication between first specialist 26 and the customer 22 to (2) the transition mode 70 which includes simultaneous communication between the first specialist 26, the customer 22 and the second specialist 28. In embodiments in which the electronic media format is two-way video conferencing, simultaneous communication may include a dual screen simultaneous display 86 of two or more of the transition mode 70 participants. For example, the customer may be presented with a dual screen display of a live video stream of the first specialist and a live stream of the second specialist (or live video streams of multiple second specialists, if such is warranted), while the specialist is presented with dual screen display of a live video stream of the customer and a live video stream(s) of the other specialist(s). In other embodiments in which the in which the media format is audio-only or text chat, simultaneous communication may include a video-stream display of the customer and the first specialist and an image of the second specialist or information related to the second specialist (e.g., name or the like). The transition mode 70 serves to create an environment for the first specialist 28 to introduce the customer 22 to the second specialist 28, as well as, a forum for the first specialist 26 to communicate the context of the transfer or other customer-related information to the second specialist 28 in the “presence” of the customer 22.

### Electronic Media Format Determination When Transferring a Customer Between Business Knowledge Sources at a Customer Service Outlet

Referring to FIG. 4, a block diagram is presented of an apparatus 100 configured for determining electronic media format when seamlessly transferring/transitioning a customer from one media-based communication session to another media-based communication session, in accordance with embodiments of the present invention. Apparatus 100 includes computing platform 102 having a memory 104 and a processor 106 in communication with memory 104. In addition, apparatus 124 may, in some embodiments, include a display 108, a video camera 110, a speaker 112 and a microphone 114, all of which are in communication with the processor 150 and may be embodied in hardware and/or software. The memory 104 of apparatus 100 stores communication module 116 that is configured to implement one or more of the display 108, the video camera 110, the speaker 112 and the microphone 114 to conduct a communication session 118 (i.e., a two-way video conference session, a one-way video conference session, an audio session, a text chat session or the like) with a customer 22. The communication module 116 includes a customer transfer routine 120 that is configured to provide the customer with seamless transfer between specialists and/or communication sources during an ongoing communication session 118.

The customer transferring routine 120 is configured to receive, during an ongoing communication session 118, a request to transfer 122 the customer to another specialist and/or, another communication source/platform or the like. The request to transfer 166 may be an input provided by either the customer 22, the specialist 26 communicating with the customer or the application/platform and may include the type of specialist and/or platform/application requested. For example, in a financial institution-based video conference system, a customer may be communicating with a mortgage/home loans specialist and during the course of the communication the specialist (or the customer) may perceive a need for the customer to communicate with a different type of specialist, (e.g., a financial advisor/wealth management advisor). The request to transfer 122 may result in identifying the second specialist 28, providing a listing of currently available second specialists 28 from which the first specialist 26 (or customer 22) may choose, or trigger queuing of the second specialist 28 (such that the next available second specialist of the type requested is the transferee specialist for the ongoing communication session 26.

In response to receiving the request to transfer 122, the customer transferring routine 120 is further configured to perform an electronic media format determination 124 to determine an electronic media format 194 to implement upon transfer (e.g., for communication between the second specialist 28 and the customer 22 or, in a self-service capacity, communication between an online/network content/presentation and the customer 22) based on application of at least one business rule 126. The electronic media format 128 may be two-way video conference, one-way video conference (customer receives video and audio feed and specialist only receives audio feed) audio-only conferencing, text chat, visual-only media, such as online/network content, application/presentation or any other conceivable media format used for communication. It should be noted that determination of the electronic media format may be based on the capabilities of the second specialist and/or the configuration of the online/network content, application/presentation. For example, in certain instances, specialists of a certain type may only be configured to communicate via audio, in which case, if the requested specialist is of that type, the media format is limited to audio-only. In other examples if the requested business knowledge source is online/network content or a presentation/application, the media format may be limited to a visual-only presentation.

Moreover, in specific embodiments in which the transfer of communication sessions is between specialists within a video conference communication session, the customer transferring routine 120 may be configured to seamlessly transfer 130 the video conferencing communication session from (1) communication between first specialist 26 and the customer 22 to (2) to communication between the first specialist 26, the customer 22 and the second specialist 28 implementing the determined electronic media format 128. In such embodiments, seamless transfer 130 may include simultaneous communication between the first specialist 26, the customer 22 and the second specialist 28. Thus, for example, if the determined electronic media format is audio conference-only, the second specialist may join an ongoing video conferencing communication session via audio-only, while the first specialist 26 and the customer 22 are communicating via video and, once the first specialist 26 hands-off the session to the second specialist 28, the remainder of the communication session concludes in audio-only conference communication. In the same regard, if the determined electronic media format is text-chat, the second specialist 28 may join the communication session via text-chat, while the first specialist 26 and the customer 22 are communicating via video. The portion of simultaneous communication allows for the first specialist 26 to instruct the customer 22 as to how to conduct the text-chat, if need be. Once the first specialist 26 hands-off the session to the second specialist 28, the remainder of the communication session concludes in text-chat only communication.

Referring to FIG. 5, a block diagram is presented of an apparatus 100 configured for determining media format when seamlessly transferring a customer amongst business knowledge sources (specialists and/or communication sources) at a customer service outlet, in accordance with embodiments of the present invention. The apparatus 100 which may include more than one physical device or unit is operable to receive and execute modules, routines and applications, such as communication module 116 and the subcomponent customer transferring routine 120 and the like.

The apparatus 100 includes a computing platform 102 that can receive and execute routines and applications. The computing platform includes memory 104, which may comprise volatile and nonvolatile memory such as read-only and/or random-access memory (RAM and ROM), EPROM, EEPROM, flash cards, or any memory common to computer platforms. Further, memory 104 may include one or more flash memory cells, or may be any secondary or tertiary storage device, such as magnetic media, optical media, tape, or soft or hard disk.

Further, the computing platform also includes at least one processor 106, which may be an application-specific integrated circuit (“ASIC”), or other chipset, processor, logic circuit, or other data processing device. Processor 106 or other processor such as ASIC may execute an application programming interface (“API”) layer (not shown in FIG. 5) that interfaces with any resident programs, such as communication module 116 and the subcomponent customer transferring routine 120 and the like, stored in the memory 104 of apparatus 100. Processor 106 includes various processing subsystems (not shown in FIG. 5) embodied in hardware, firmware, software, and combinations thereof, that enable the functionality of apparatus 100 and the operability of the apparatus on a network. For example, processing subsystems allow for initiating and maintaining communications, and exchanging data, with other networked devices. Additionally, processing subsystems may include any portion of the functionality of communication module 116 obviating the need for such applications and modules to be stored in the memory.

As previously noted in relation to FIGS. 1-4, apparatus 100 includes one or more of display 108, video camera/image capturing device 110, speaker 112 and microphone 114, which are all in communication with processor 106.

The memory 104 of apparatus 100 stores communication module 116 that is configured to implement at least one of the display 108, the video camera 110, the speaker 112 and the microphone 114 to conduct a communication session 118 (e.g., a video chat session or the like) with a customer 22 that is located at a communication source (e.g., video conference apparatus 20 of FIG. 1). The communication module 116 includes a customer transferring routine 120 that is configured to provide the customer with seamless transfer between specialists during an ongoing communication session 118.

In specific embodiments, the customer transferring routine 120 is configured to receive, during the ongoing communication session 118 between the customer 22 and the first specialist 26, a request to transfer 122 the communication to a second specialist 28. It should be noted that a second specialist 28 may include more than one specialist (e.g., different types of specialties for each specialist) in those instances in which more than one specialist is needed or required by the customer. As previously noted the request 122 may comprise an input provided by either the first specialist 26 or the customer 22 and may include the type of specialist requested. In certain embodiments, the customer transfer routine 120 may be configured to allow the customer to initiate a transfer to another specialist of the same type in the event the customer 22 is experiencing communication problems (e.g., technical problems) with the first specialist 26 or believes that they would be better serviced by another specialist. In other specific embodiments, the first specialist 28, through communications with the customer 22, may perceive the need for a different type of specialist and, in response to asking and confirming that the customer desires a transfer to another specialist at the conclusion of their discussions, provides the request input indicating the need for the transfer.

As previously discussed in relation to FIG. 4, the request to transfer 122 may result in any one of (a) identifying the second specialist 28, (b) providing a listing of available second specialists 28 from which the first specialist 28 (or customer 22) may choose the appropriate second specialist 28 and/or (c) trigger queuing of the second specialist 28 (such that the next available specialist of the type requested is the transferee/second specialist 28 for the ongoing communication session 118. Queuing of the second specialist 28 may insure that the second specialist 28 is on-hand, waiting to join the transfer/transition mode 130 when the customer 22 and the first specialist 26 are ready to move into the transition mode 130. In other embodiments of the invention, the customer transferring routine 120 may be configured to alert the first specialist (and/or customer 22) when the second specialist has been identified and/or when the second specialist is ready to move to the seamless transfer mode 130 of communication. Identification of the second specialist may be necessary, in those embodiments of the invention that require communication of customer information to the second specialist 28 prior to the seamless transfer 130.

In response to receiving the request to transfer 122, the customer transferring routine 120 is further configured to determine an electronic media format 124 to implement upon transfer (i.e., for communication between the second specialist 28 and the customer 22) based on application on at least one business rule 126. The electronic media format may be two-way video conferencing, one-way video conferencing audio-only conferencing, text chat or any other conceivable media format used for communication. The business rule 126 may be based on customer status 132 such that a customer having a preferred (i.e., elevated) status may be provided video format, while a customer of a standard/non-preferred status may be provided a lesser media format, such as audio-only or text chat. In additional embodiments of the invention, the business rule 126 may be based on customer profile information 134. For example, the customer profile information 134 may indicate which media format the customer prefers or may provide information about an attribute that is paramount to media format determination (i.e., the customer has a preferred language or the customer has a disability, such as hearing impaired or the like). In other embodiments of the invention, the business rule 126 may be based on historical interactions/transactions 136 conducted with the customer. For example, the historical interactions 136 may indicate difficulty interacting with the customer or difficulty pleasing the customer, in such instances, the video format may be preferred to insure that the customer of provided the utmost attention and care.

In other embodiments of the invention, the business rule 126 applied to determine the media format 124 may be based on the reason for the transfer/type second specialist 138. For example, if the transfer is because the customer is unsatisfied with the current specialist or desires another specialist, the media format may be video to insure proper attention and care is given to the customer. In other embodiments, in which certain types of specialists (e.g., certain lines-of-business or the like) may be limited to communication via certain types of media, the type of the second specialist may dictate the determined media format.

In still further embodiments of the invention, the business rule 126 applied to determine the media format 124 may be based on the shortest queue time 140. In certain instances, in which the customer may be unwilling to wait for certain type of media format, the media format with the shortest wait time (i.e., queue) may be chosen or the queue time may be one factor in determining the media format. In other embodiments of the invention, the business rule 126 applied to determine the media format 124 may be based on media format availability 143. For example, network disruptions or the like may result in certain media formats being currently unavailable, in which cases other media formats may be determined to accommodate the need for a timely transfer.

In alternate embodiments, not shown in FIG. 5 but which are described in detail in relation to FIGS. 2 and 3, the communication module 116 may include a customer information exchange rules engine 74 that applies one or more business rules 76 to information related to the customer to determine what information is suitable to communicate to the second specialist prior to seamlessly transferring the communication session to the second specialist.

As noted in relation to FIG. 4, the customer transferring routine 120 is configured to seamlessly transfer 130 the communication session from (1) communication between first specialist 26 and the customer 22 to (2) to communication between the first specialist 26, the customer 22 and the second specialist 28 implementing the determined media format 128. In such embodiments, seamless transfer 130 may include simultaneous communication 144 between the first specialist 26, the customer 22 and the second specialist 28. Thus, for example, if the determined media format is audio-only, the second specialist will join the communication session 118 via audio-only, while the first specialist 26 and the customer 22 are communicating via video and, once the first specialist hands-off the session to second specialist, the remainder of the communication session 118 concludes in audio-only communication. In the same regard, if the determined media format 128 is text-chat, the second specialist 28 will join the communication session 118 via text-chat, while the first specialist 26 and the customer 22 are communicating via video.

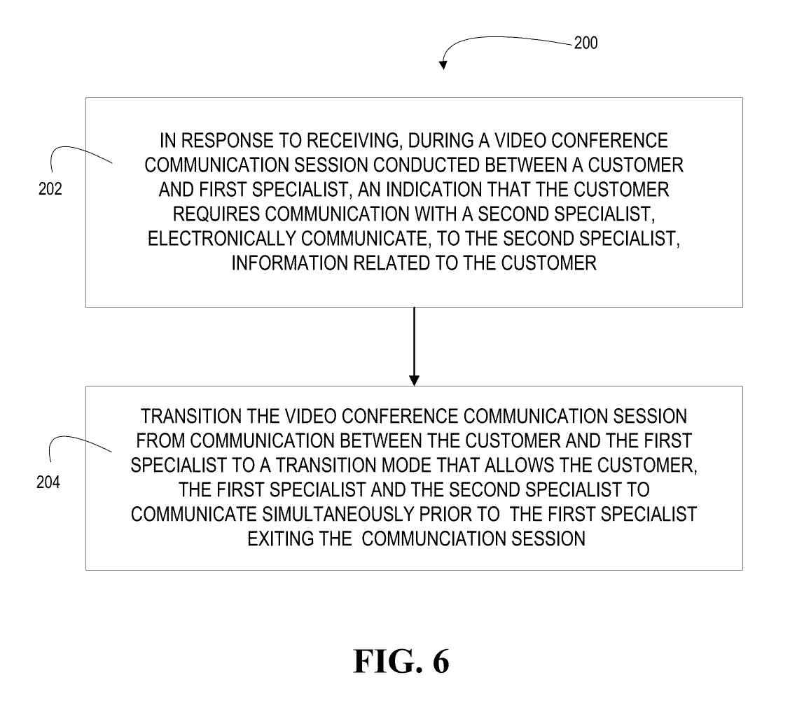

Referring to FIG. 6, a flow diagram is presented of a method 200 for seamless customer transfer from one specialist to another specialist during an ongoing video conference communication session, in accordance with embodiments of the present invention. At Event 202, in response to receiving, during a video conference communication session conducted between a customer and a first specialist, an indication (or request) that the customer requires communication with a second specialist, electronically communicating, to the second specialist, customer information (e.g., customer profile information and/or information obtained from the customer during the current communication session). In specific embodiments, the indication that the customer requires communication may provide for receipt of an input from either the first specialist or the customer that is configured to request the transfer (communication with the second specialist). In such embodiments, the input, which may include the type of second specialist requested, may be configured to identify the second specialist, present a listing of second specialists currently available and/or place the customer in a queue for the second specialist. In specific embodiments, in which no specific second specialist is selected or the selected second specialist is immediate available, the customer may by immediately presented the transition mode without having to be placed in a queue. In such embodiments, the information that is communicated to the second specialist may occur in immediate response to receiving the indication that the customer requires communication with a second specialist.

In other specific embodiments of the method, communicating the customer information may include implementing a customer information exchange rules engine to determine what information can be passed along to the second specialist, absent customer consent. In other specific embodiments of the method, communicating the customer information may include providing the customer an information exchange option that allows the customer to consent to information exchange to the second specialist.

At Event 204, the video conference communication session is transitioned from communication between the customer and the first specialist to a transition mode that allows the first specialist, the second specialist and the customer to communicate simultaneously prior to the first specialist handing-off the communication session to the second specialist. In specific embodiments of the method such transitioning includes presenting a dual screen display to the customer, first specialist and second specialist that includes live video streams of the first specialist, the second specialist and the customer, such that, during the transition mode, the customer views live video streams of the first and second specialists and the first and second specialists view live video streams of the customer and the other specialist. In other embodiments, simultaneous communication may include a video stream display of the customer and the first specialist and an image of the second specialist or information related to the second specialist (e.g., name or the like).

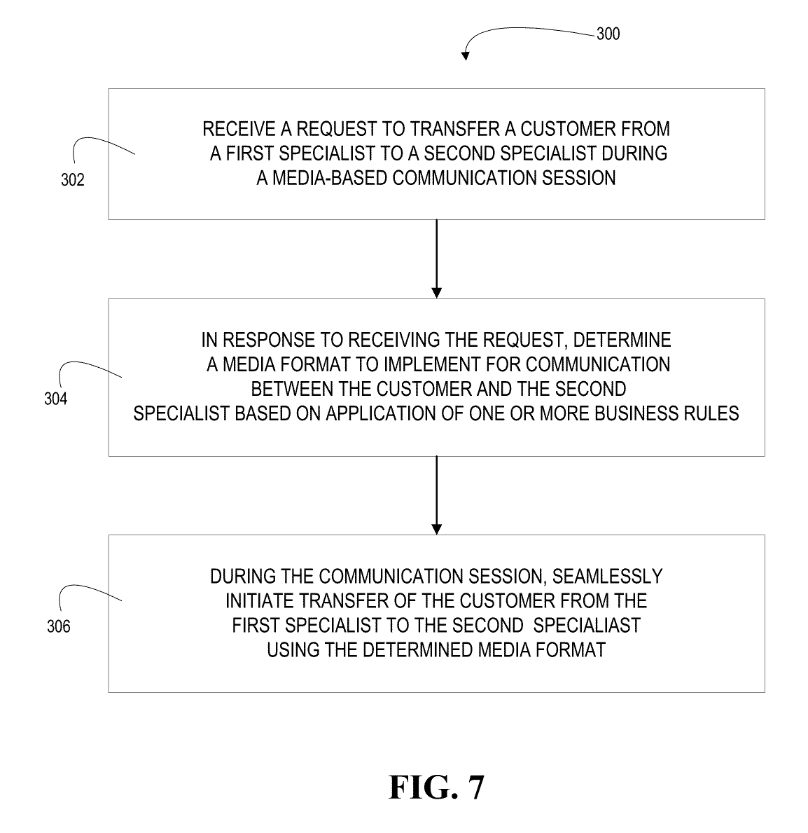

Referring to FIG. 7, a flow diagram is presented of a method 300 for determining media format for customer transfer from one specialist to another specialist during an ongoing communication session, in accordance with embodiments of the present invention. At Event 302, during a media-based communication session conducted between a customer and a first specialist, a request is received to transfer a customer from a first specialist to a second specialist. In specific embodiments, the request is an input from either the first specialist or the customer that is configured to request the transfer (communication with the second specialist). In such embodiments, the input, which may include the type of second specialist requested, may be configured to identify the second specialist, present a listing of second specialists currently available and/or place the customer in a queue for the second specialist.

At Event, 304 in response to receiving the request, a media format is determined which will be implemented for communication between the second specialist and the customer during the ongoing communication session. The determination of the media format is based on application of one or more business rules. The business rules may be based on the status of the customer at the business, customer profile/preferences information or customer information obtained during the current communication session. Moreover, the business rules may be based on historical interactions with the customer, the reason for the transfer and/or the type of second specialist requested. In additional embodiments of the invention, the business rules may take into account the shortest queue/wait time for a media format or the current availability of a media format.

At Event 306, the communication session is seamlessly transitioned from communication between the customer and the first specialist to a transition mode that allows the first specialist, the second specialist and the customer to communicate simultaneously prior to the first specialist handing-off the communication session to the second specialist. In specific embodiments of the method, in which the determined media format is video, such transitioning includes presenting a dual screen display to the customer, first specialist and second specialist that includes live video streams of the first specialist, second specialist and customer, such that, during the transition mode, the customer views live video streams of the first and second specialists and the first and second specialists view live video streams of the customer and the other specialist. In other embodiments of the invention, the simultaneous communication may provide for the first specialist and customer to continue communicating in video format while the customer, and in some embodiments, the first specialist communicate with the second specialist in the determined media format.

### Addition of Third Parties to Customer-Bank Communication via a Video Conference System

The present invention is directed to apparatuses, methods, and computer program products that enable the addition of third parties to customer-entity communication via a video conference system. The video conference system is typically a video teleconferencing system that is installed in a dedicated, isolated room where a user (e.g., a third party) can deliver or receive a personalized service based on a request for service. The video conference system enables users who are spread across multiple locations to communicate in real time.

When a customer approaches an agent (e.g., a teller, a specialist, a customer service representative, a manager, an associate, or the like) associated with the entity with a request, the agent typically will utilize all resources within her or his power to complete execution of the request. For example, if the customer requests a withdrawal at a bank teller window, the bank teller will prompt the customer for information (e.g., a personal identification (PIN), account information, personal information, contact information, or the like) necessary to complete execution of the withdrawal, authenticate the customer, withdraw the requested funds, and provide the funds to the customer.

However, the customer may also request a service or a type of service that requires more information, additional authentication, or resources that are not readily accessible by the agent. For example, the customer may request a loan for a mortgage. Included in the entity's processing of the mortgage loan request is supervisory authentication of the customer's credit by an accountant associated with a third party accounting firm. The accountant (e.g., the third party) may or may not have an existing relationship with the customer, the entity, the agent, or the like.

In some embodiments, the customer may initiate the request in person. For example, the customer may walk into a physical location associated with the entity and speak directly with the agent. In other embodiments, the customer may initiate the request via an automated teller machine (ATM), a smart phone, a telephone, a radio communication device, a laptop computer, a tablet, a desktop computer, a wearable computing device, or another computing device configured to receive, process, distribute, and/or execute the request. The device is operated by a user (e.g., a customer, the agent, or another person either associated or not associated with the entity.

The user may, via an interface, input information associated with the request. For example, the user may be prompted to designate a request type. Information associated with the request includes a request type, a time and/or date of request, a request number, account information (e.g., an account number, a routing number, an account balance, or the like), contact information (e.g., name, a username, an email address, a physical address, a phone number, or the like), authentication information (e.g., a personal identification number (PIN), a password, an answer to a security question, a biometric, or the like), location information (e.g., longitude and latitude coordinates, an IP address, global positioning system (GPS) coordinates, or the like), or the like. In other embodiments, information may be retrieved by the apparatus and therefore no user input may be necessary. The information associated with the request is transmitted to the apparatus and may be stored in a database, a datastore, or other memory location.

The apparatus receives the request and information associated with the request so that the apparatus can process the request. In some embodiments, the agent is required to provide an input to the apparatus. In other embodiments, no input is required from the agent to initiate processing of the request.

Processing the request includes determining, via a computing device associated with the apparatus, which services are required to complete execution of the request. Each request type may require a different set of steps to complete execution of the request. For example, a request associated with a withdrawal may require relatively few authentication steps (e.g., a Personal Identification Number (PIN)), while a request associated with a mortgage loan may require more authentication steps (e.g., a credit check, a background check, an income statement, or the like). Processing the request further includes determining a communication type, such as voice, video, text, or the like.

Processing the request further includes determining a set of skills associated with each user, agent, or third party. In this way, the apparatus may determine which agent or third party needs to be added to the communication to complete processing of the customer's request. For example, if the customer requests a mortgage loan, then the apparatus determines that a third party mortgage loan specialist (e.g., an agent associated with the entity that is offsite in a mortgage loan-headquartered location) is required for processing the mortgage loan request. The apparatus may also determine which types of communication are accessible to the third party, as well as the user, customer, or agent, so that communication between all users is optimized for bandwidth and/or communication quality purposes. The apparatus is configured to enable one or more users to transfer between other users with different skills or access to various technologies.

In some embodiments, the apparatus prompts the user or the agent for one or more authentication credentials, information required to complete execution of the request, or other input types. In other embodiments, a third party may be required to become involved with processing of the request in order to complete execution of the request. For example, the agent responsible for processing the request may not have access to a particular suite of functions required to complete execution of the request.

In some embodiments, the third party is associated with the entity. For example, the third party may be an agent, a specialist, a customer service representative, a manager, an associate, a teller, a notary, or the like associated with the entity. In other embodiments, the third party is not associated with the entity. For example, the third party may be a spouse, friend, or relative of the customer, a financial services professional (e.g., an accountant, a tax advisor, a portfolio manager, a financial advisor, or the like) associated with another entity, or the like.

Authentication of the third party may be required in order for the third party to be added to communication between the user and the agent. For example, the third party may be required to input a password, a passcode, take a picture, a biometric, an extension number, a gesture, a rhythmic or pressure-based input, or another authentication credential to not only verify the identity of the third party attempting to join communication between the user and the agent, but also to enable the third party to join communication between the particular user and the particular agent. In another embodiment, the user, the agent, or the third party may be required to provide an audible signal (e.g., a speech signal), and the apparatus is configured to determine the authenticity of the user, the agent, or the third party through voice identification or recognition. Additionally, the apparatus may combine multiple layers of authentication. For example, the user may be required to input a PIN and provide a biometric fingerprint scan, which are both received by the apparatus for processing. Moreover, authentication may be associated with a device. For example, the third party may attempt to join communication between the user and the agent via a smartphone, which has a device identification (ID). The apparatus may receive the device ID (perhaps along with another authentication input) of the smartphone and determine, through a predetermined association between the third party and the smartphone, that the third party is authenticated.

The apparatus then compares received inputs to a database of predetermined authentication credentials associated with authentication of the third party. More specifically, authentication of the third party ensures that the third party is added to the correct line of communication and not added to a line of communication where the third party is not needed or request or is not authorized to access. In other embodiments, authentication of the third party is not required.

In some embodiments, the user or the agent is enabled to register or pre-register (e.g., register prior to be added to the line of communication between the user and the agent) the third party so that the third party can join the line of communication between the user and the agent without being required to input an authentication credential. For example, registration includes inputting the third party's name into a list of authenticated third parties, or the like. In other embodiments, the third party is enabled to register or pre-register itself. Pre-registration of the third party typically includes processing information associated with the third party, including but not limited to a name, contact information, account information, information associated with a device, authentication information, or the like. In alternative embodiments, the third party is registered or authorized in real time (e.g., substantially simultaneously to joining the line of communication between the user and the agent). For example, the apparatus is configured to determine the authenticity of the third party upon requesting to join the line of communication between the user and the agent. The apparatus is configured to retrieve, receive, analyze, or process information associated with the third party (e.g., account information, contact information, authorization information, location information, or the like) to determine the authenticity of the third party in real time.

The third party may also be provided a temporary token or an access code to join the communication between the user and agent. For example, a one-time use passcode may be provided to the third party. Alternatively, the passcode may be permanent or valid for a predetermined number of uses and may be encrypted for protective purposes. The apparatus is further configured to enable the user, the agent, and/or the third party to schedule an appointment for communication, and authorization may be scheduled or registered for a predetermined period of time, a time or day, or the like. Limits may be configured to be placed on the third party (or another user) by the user, the agent, and/or the third party. For example, authentication of the third party may be limited to a particular telephone number or area code, IP address, or the like and communication may be accessible only for a particular period of time.

The third party may also be added to the communication between the user and agent on the fly. For example, if the agent requires information from a mortgage loan specialist, the agent dials the extension of the mortgage loan specialist and the mortgage loan specialist is added to the communication between the user and agent on the fly. Authentication of the third party may be granted simply based on the user or the agent requesting assistance from the third party.

The apparatus is configured to connect the third party to the communication between the user and agent. In some embodiments, the third party is connected to the communication between the user and agent via a video stream, an audio stream, a text conversation, or another method. For example, the third party may be displayed to the user and/or the agent via a display, a screen, a speaker, a text box, a conversation window, or the like associated with the apparatus or another device. Either audio, video, or both audio and video may be transmitted in the communication between the user, agent, and or third party. The communication may be a two-way communication (e.g., both the user and the agent can see and hear each other and the third party), a one-way communication (e.g., only the third party can see and hear the user and agent, while everyone can hear each other). The apparatus is configured to determine a bandwidth of the communication so as to optimize a communication type. For example, if a strong signal (e.g., high bandwidth) is detected, then the apparatus may commence a video and audio stream-type communication, whereas a detected weaker signal (e.g., low bandwidth) may commence an audio-only-type communication.

During communication, the apparatus is configured to track communication between the user, the agent, and/or the third party. The apparatus is configured to record video, audio, or transpose video and/or audio into text so that a transcript or call log is generated. The apparatus tracks a time or date associated with the communication, any and all participants of the communication, the method through which each of the participants joined (e.g., a video chat, a telephone call, or the like), information associated with each participant (e.g., account, contact, authentication, or location information, or the like), a duration of the communication, or other metrics. The apparatus is also configured to generate a report (e.g., a message, an email, or the like) and transmit the report to the user, the agent, the third party, an administrator, or another user. The apparatus may further determine a velocity or frequency of communication (e.g., how many times each user or third party has communicated, and via which methods) so as to optimize application of user preferences to joining the third party to the communication between the user and the agent.

The apparatus may be integrated with an existing software platform configured to enable the agent, the user, a customer, or the third party to execute one or more actions (e.g., complete a transaction, open an account, inquire about a loan, or the like). The apparatus may also exist as a standalone communication application. The apparatus typically enables the sharing and/or storing of content between communicators (e.g., the user, the agent, and the third party).

The apparatus is configured to support users with disabilities. For example, the apparatus may transpose audio to text for a hearing-impaired user. Additionally, the apparatus may determine that the hearing-impaired user requires speaking with an agent or a third party that knows sign language so that the hearing-impaired user can better communicate his or her request.

As an example, a joint account holder initiates a request to execute a transaction that is typically bound by governing regulatory bodies. However, the joint account holder's partner, who also holds an interest in the joint account and is required to be present to execute the transaction, is located in a different city than the first joint account holder. Furthermore, a document required to execute the transaction must be notarized. So, the two joint account holders may be joined in communication with each other and an agent associated with the entity after providing user authentication. A notary associated with the entity who is pre-registered for the communication but is located in a third city is also added to the communication to witness signing of documents and notarize the document electronically. In this way, the apparatus is configured to connect multiple users across the globe to complete tasks in a timely and cost-efficient manner.

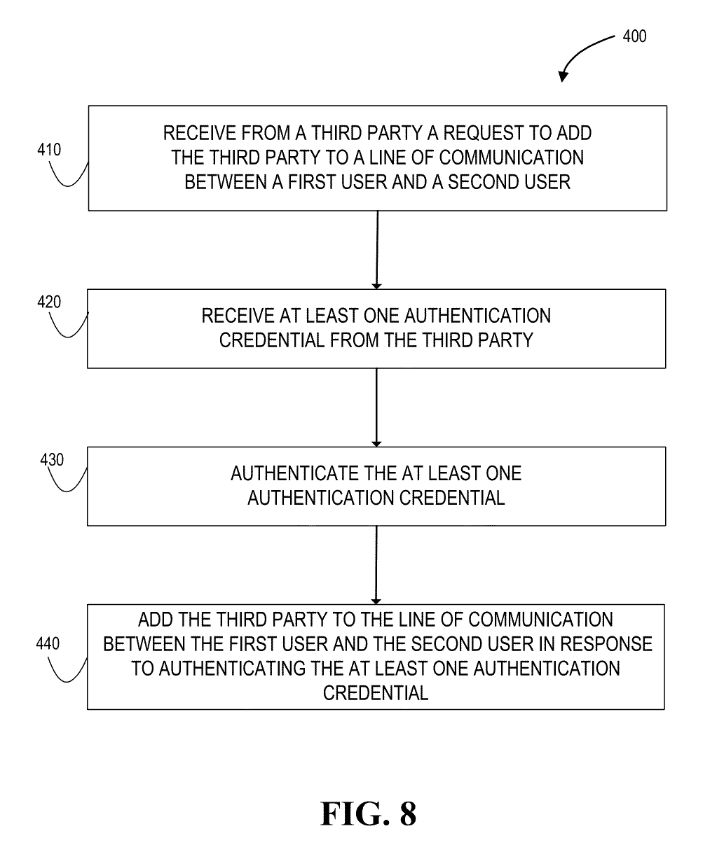

Now referring to the figures, FIG. 8 is an exemplary process flow 400 for a adding a third party to a line of communication between a first user and a second user via a video conference system. At block 410, the process includes receiving from the third party a request to add the third party to the line of communication between the first user and the second user. At block 420, the process includes receiving at least one authentication credential from the third party. At block 430, the process includes authenticating the at least one authentication credential. At block 440, the process includes adding the third party to the line of communication between the first user and the second user in response to authenticating the at least one authentication credential.

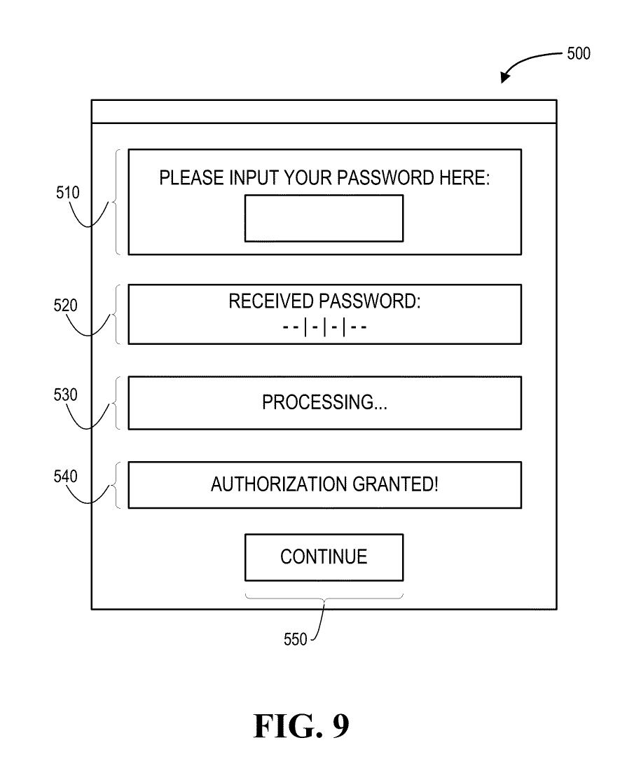

FIG. 9 is an exemplary user interface 500 for authenticating the third party. The exemplary interface 500 may be presented to the third party (or the user or the agent) when authentication of the third party is required to add the third party to communication between the user and the agent. For example, the apparatus may present the interface 500 to the third party via a display for authentication after the third party has requested to be added to the communication between the user and the agent. In some embodiments, the user, the agent, the third party, or another user is enabled to configure which actions or functions require user authentication, and which actions or functions correspond to each level of authentication. A continuum of strength of authentication may be associated with a continuum of user access and may be integrated with the present invention.

The apparatus is typically associated with a device (e.g., a smart phone, a personal digital assistant (PDA), a tablet, an ATM, a laptop computer, a desktop computer, a smart watch, a wearable computing device such as a ring, a bracelet, or other jewelry, or the like) that is configured to display the interface 500. The device may include at least one touch screen, at least one button, a combination of buttons and screens, or the like. The apparatus is further integrated with an application or operating system installed or accessed by the device.

As shown in FIG. 9, the interface 500 typically directs the third party through the authentication process 500. Via the interface 500, the apparatus prompts the third party for input of an authentication credential 510 via a message, a notification, an alert, an instruction, a prompt, or the like as shown in FIG. 9. The user may transmit many types of inputs, including inputs associated with the device such as a button press, a button hold, a button tap, a button slide, a touch screen tap, a touch screen hold, a touch screen press or selection, a touch screen swim, a mouse click, a scroll, a toggle, a selection, a zoom, a knock, a download, a biometric interaction, an upload, or another action. In some embodiments, the user may be pre-registered with the apparatus and therefore an authentication credential 510 may not be required.

The apparatus receives one or more inputs or a string of inputs (e.g., the authentication credential input by the third party) via at least one sensor associated with the device. Sensors may be integrated into the device, such as on a device button, or may be integrated within software installed on the device (e.g., within an application or operating system). The sensors are configured to determine at least an input type, an input length, an input duration, an input time (e.g., a time at which the input was received), a length of time between receiving multiple inputs, a rhythm, a tempo, a velocity, a pitch, or the like of each input. The apparatus may include a space on a touchscreen, a button, or another surface that is designated or configured to receive inputs from the third party, such as the block in the input prompt 510 of FIG. 9. The space may define pixel dimensions such as a length and a width that is configured to receive inputs via a sensor. In other embodiments, the apparatus may include no designated space for sensing inputs, or the entirety of the apparatus may be configured to sense inputs via one or more sensors. The apparatus is configured to determine a location associated with the sensed input. For example, the apparatus may use pixels to identify the location of a sensed input. The apparatus is further configured to store each received input, as well as information associated with the input (e.g., input type, tempo, velocity, or the like) in a storage location in memory. Alternatively, authentication may be required to be inputted by the third party in a designated, customizable area, which in some embodiments is scalable, configurable, modifiable, or the like by the user. The apparatus may display the received input 520 as seen in the interface 500 in FIG. 9.

Once received, the inputs (e.g., the authentication credential) are processed by the apparatus, which may display a processing status 530 via the interface 500 as illustrated in FIG. 9. Processing of the received inputs includes determining if the third party is to be authenticated. The apparatus compares the received inputs to one or more stored predetermined sequences of inputs associated with positive authentication of the user (e.g., the user's password).

The third party, the user, the agent, or another user, such as an administrator, is typically enabled to configure the password as stated above. The apparatus may provide means for editing, modifying, changing, adding, or deleting a password for one or more third parties or users. Multiple third parties may share the same password, or multiple users may each have his or her own unique password. In other embodiments, an administrator may configure the password for one or more third parties.

The apparatus determines if the received inputs match one or more predetermined sequences of inputs associated with positive authentication of the third party. The apparatus is configured to determine the identity of the third party through the manner in which the inputs are received. The apparatus may analyze the received inputs and information associated with the received inputs (e.g., input type, rhythm, tempo, or the like) to authenticate the third party.

In some embodiments, the received inputs completely match one or more predetermined sequences of inputs associated with positive authentication of the third party. In other embodiments, the received inputs partially match one or more predetermined sequences of inputs associated with positive authentication of the third party. In alternative embodiments, the received inputs do not match one or more predetermined sequences of inputs associated with positive authentication of the third party.

Based on determining a match between the received inputs and one or more predetermined sequences of inputs associated with positive authentication of the third party, the apparatus may authenticate the third party to various levels of authentication. For example, if there is a complete match, the third party is fully authenticated and has full access to all functions within an application or the communication system of the present invention. If there is a partial match, the third party is partially authenticated and has access to some functions within the application or the communication system of the present invention, and does not have access to other functions within the application or the communication system of the present invention. If there is no match, the third party is denied and does not have access to any functions within the application or the communication system of the present invention. The levels of authentication are predetermined and configurable by the user, the agent, the third party, or another user (e.g., an administrator).

The level of authentication may further be defined by a level of complexity associated with the received inputs or one or more predetermined sequences of inputs associated with positive authentication of the user. For example, if received inputs are short in length or contains a number of inputs smaller than a predetermined threshold value, then, upon positive determination that the received inputs at least partially match a predetermined sequence of inputs associated with positive authentication of the third party, the third party is partially authenticated. Conversely, if received inputs are long in length or contains a number of inputs larger than a predetermined threshold value, then, upon positive determination that the received inputs at least partially match a predetermined sequence of inputs associated with positive authentication of the third party, the third party is fully authenticated.

Upon successful authentication of the third party, the apparatus may be configured to execute an action substantially simultaneously to or after positive authentication is determined, such as adding the third party to a line of communication between the user and the agent. Other actions may be executed depending on the application, device, or operating system within which the apparatus is integrated. The user may be required to select “Continue” 950 to initiate execution of the action.

Upon failed authentication of the user, the apparatus is configured to present to the third party a second interface for reattempting user authentication. The apparatus may also close an application, require additional authentication, turn off a device associated with the apparatus, or perform another action.

The present invention may further be coupled with additional layers of authentication and so the apparatus may prompt the third party for additional authentication credentials such as a password, an answer to a security question, a personal identification number (PIN), a puzzle, a biometric, or the like. The apparatus may also utilize location information (global positioning system (GPS) coordinates, longitude and latitude, proximity to landmarks or transmission towers, or the like) to authenticate the third party. Third party access to various functions may require one or more additional layers of authentication.

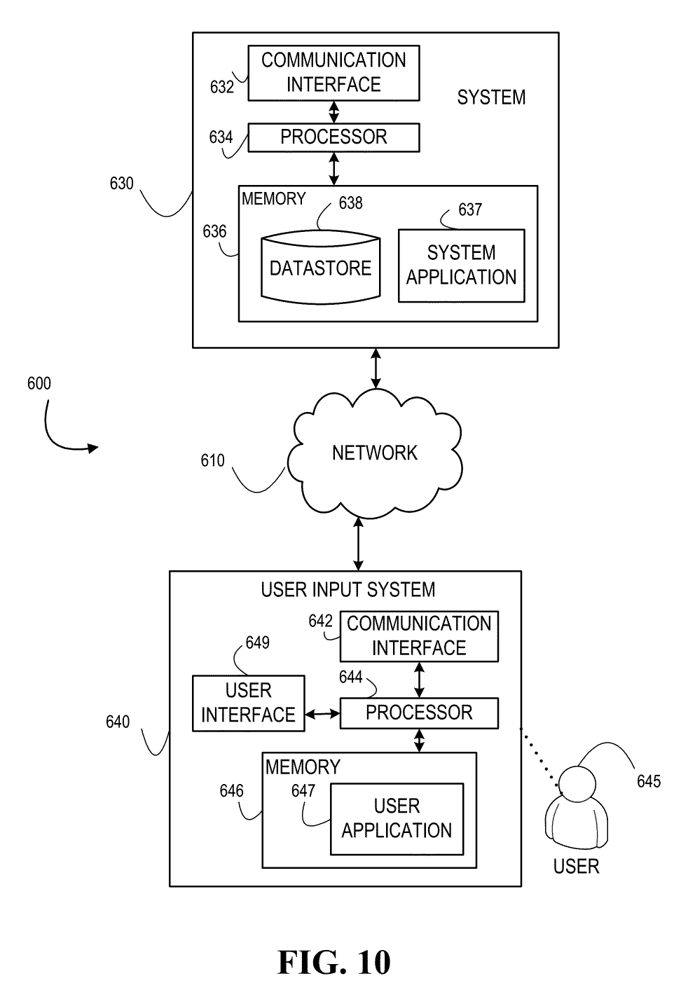

FIG. 10 is an exemplary block diagram illustrating technical components of a system 600 for a adding a third party to a line of communication between a first user and a second user via a video conference system as described in the process flow described in FIG. 8 and the exemplary interface in FIG. 9. As illustrated, the system environment 60 includes a network 610, a system 630, and a user input system 640. Also shown in FIG. 10 is a user 645 of the user input system 640. The user input system 640 may be any computing device. The user 645 may be a person who uses the user input system 640 to execute a user application 647. The user application 647 may be an application to communicate with the system 630, perform a transaction, input information onto a user interface presented on the user input system 640, or the like. The user application 647 and/or the system application 637 may incorporate one or more parts of any process flow described herein.

As shown in FIG. 10, the system 630, and the user input system 640 are each operatively and selectively connected to the network 610, which may include one or more separate networks. In addition, the network 610 may include a telecommunication network, local area network (LAN), a wide area network (WAN), and/or a global area network (GAN), such as the Internet. It will also be understood that the network 610 is secure and may also include wireless and/or wireline and/or optical interconnection technology.

The user input system 640 may include any computerized apparatus that can be configured to perform any one or more of the functions of the user input system 640 described and/or contemplated herein. For example, the user 645 may use the user input system 640 to transmit and/or receive information or commands to and from the system 630. In some embodiments, for example, the user input system 640 may include a personal computer system (e.g. a non-mobile or non-portable computing system, or the like), a mobile computing device, a personal digital assistant, a mobile phone, a tablet computing device, a network device, a wearable computing device, a sensor, and/or the like. As illustrated in FIG. 10, in accordance with some embodiments of the present invention, the user input system 640 includes a communication interface 642, a processor 644, a memory 646 having a user application 647 stored therein, and a user interface 649. In such embodiments, the communication interface 642 is operatively and selectively connected to the processor 644, which is operatively and selectively connected to the user interface 649 and the memory 646. In some embodiments, the user 645 may use the user application 647 to execute processes described with respect to the process flow and interfaces described herein. Specifically, the user application 647 executes the process flow described in FIG. 8.

Each communication interface described herein, including the communication interface 642, generally includes hardware, and, in some instances, software, that enables the user input system 640, to transport, send, receive, and/or otherwise communicate information to and/or from the communication interface of one or more other systems on the network 610. For example, the communication interface 642 of the user input system 640 may include a wireless transceiver, modem, server, electrical connection, and/or other electronic device that operatively connects the user input system 640 to another system such as the system 630. The wireless transceiver may include a radio circuit to enable wireless transmission and reception of information. Each processor described herein, including the processor 644, generally includes circuitry for implementing the audio, visual, and/or logic functions of the user input system 640. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 647 of the memory 646 of the user input system 640.

Each memory device described herein, including the memory 646 for storing the user application 647 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 10, the memory 646 includes the user application 647. In some embodiments, the user application 647 includes an interface for communicating with, navigating, controlling, configuring, and/or using the user input system 640. In some embodiments, the user application 647 includes computer-executable program code portions for instructing the processor 644 to perform one or more of the functions of the user application 647 described and/or contemplated herein. In some embodiments, the user application 647 may include and/or use one or more network and/or system communication protocols.

Also shown in FIG. 10 is the user interface 649. In some embodiments, the user interface 649 includes one or more output devices, such as a display and/or speaker, for presenting information to the user 645. In some embodiments, the user interface 649 includes one or more input devices, such as one or more buttons, keys, dials, levers, directional pads, joysticks, accelerometers, controllers, touchpads, touchscreens, haptic interfaces, microphones, scanners, motion detectors, cameras, and/or the like for receiving information from the user 645. In some embodiments, the user interface 649 includes the input and display devices of a mobile device, which are operable to receive and display information.

FIG. 10 also illustrates a system 630, in accordance with an embodiment of the present invention. The system 630 may refer to the “apparatus” described herein. The system 630 may include any computerized apparatus that can be configured to perform any one or more of the functions of the system 630 described and/or contemplated herein. In accordance with some embodiments, for example, the system 630 may include a computer network, an engine, a platform, a server, a database system, a front end system, a back end system, a personal computer system, and/or the like. Therefore, the system 630 may be a server managed by the entity. The system 630 may be located at the facility associated with the entity or remotely from the facility associated with the entity. In some embodiments, such as the one illustrated in FIG. 10, the system 630 includes a communication interface 632, a processor 634, and a memory 636, which includes a system application 637 and a datastore 638 stored therein. As shown, the communication interface 632 is operatively and selectively connected to the processor 634, which is operatively and selectively connected to the memory 636.

It will be understood that the system application 637 may be configured to implement any one or more portions of the various user interfaces and/or process flow described herein. The system application 637 may interact with the user application 647. It will also be understood that, in some embodiments, the memory includes other applications. It will also be understood that, in some embodiments, the system application 637 is configured to communicate with the datastore 638, the user input system 640, or the like.

It will be further understood that, in some embodiments, the system application 637 includes computer-executable program code portions for instructing the processor 634 to perform any one or more of the functions of the system application 637 described and/or contemplated herein. In some embodiments, the system application 637 may include and/or use one or more network and/or system communication protocols.

In addition to the system application 637, the memory 636 also includes the datastore 638. As used herein, the datastore 638 may be one or more distinct and/or remote datastores. In some embodiments, the datastore 638 is not located within the system and is instead located remotely from the system. In some embodiments, the datastore 638 stores information or data described herein.

It will be understood that the datastore 638 may include any one or more storage devices, including, but not limited to, datastores, databases, and/or any of the other storage devices typically associated with a computer system. It will also be understood that the datastore 638 may store information in any known way, such as, for example, by using one or more computer codes and/or languages, alphanumeric character strings, data sets, figures, tables, charts, links, documents, and/or the like. Further, in some embodiments, the datastore 638 may include information associated with one or more applications, such as, for example, the system application 637. It will also be understood that, in some embodiments, the datastore 638 provides a substantially real-time representation of the information stored therein, so that, for example, when the processor 634 accesses the datastore 638, the information stored therein is current or substantially current.

It will be understood that the embodiment of the system environment illustrated in FIG. 10 is exemplary and that other embodiments may vary. As another example, in some embodiments, the system 630 includes more, less, or different components. As another example, in some embodiments, some or all of the portions of the system environment 600 may be combined into a single portion. Likewise, in some embodiments, some or all of the portions of the system 630 may be separated into two or more distinct portions.

In addition, the various portions of the system environment 600 may be maintained for and/or by the same or separate parties. It will also be understood that the system 630 may include and/or implement any embodiment of the present invention described and/or contemplated herein. For example, in some embodiments, the system 630 is configured to implement any one or more of the embodiments of the process flows described and/or contemplated herein in connection any process flow described herein. Additionally, the system 630 or the user input system 640 is configured to initiate presentation of any of the user interfaces described herein.

Thus, systems, apparatus, methods, and computer program products described above provide for seamlessly transferring customers from one specialist to another specialist during an ongoing video conference communication session. In specific embodiments of the invention, simultaneous communication is provided amongst the customer, the transferor (or first) specialist and the transferee (or second) specialist, prior to the first specialist departing the communication session. In one specific embodiment, simultaneous communication provides for dual screen display, in which the customer views and communicates with both specialists simultaneously, while the specialists view and communicate with the customer and the other specialist. In additional embodiments of the invention, in which information pertaining to the customer may have privacy concerns, customer information exchange rules are implemented to automatically determine which information accessible to the first specialist can be communicated to the second specialist. Thus, the seamless transfer between specialists eliminates the need and the delays associated with separate video conference communication sessions.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for transferring a customer between specialists in a video conferencing environment, the system comprising:
a video conferencing apparatus located within a private setting in the business location and including a computing platform having:
a processor,
a display in communication with the processor,
a video camera in communication with the processor,
a speaker in communication with the processor, and
a microphone in communication with the processor,
wherein the first video conferencing apparatus is configured to implement a plurality of the display, the video camera, the speaker and the microphone to provide a customer a communication platform for conducting a video conference communication session with a specialist located remote from the business location; and
a customer transferring module stored in a memory, executable by a processor and configured to, in response to (i) receiving, during a video conference communication session conducted between a customer and a first specialist, an indication that the customer requires communication with a second specialist, and (ii) communicating, to the second specialist, information related to the customer, transition the video conference communication session between the customer and the first specialist to a transition mode that allows the customer, the first specialist and the second specialist to communicate simultaneously prior to the first specialist exiting the video conferencing communication session.

2. The system of claim 1, wherein the customer transferring module further comprises a customer information exchange rules engine that is configured to apply business rules to determine the information related to the customer that is approved to be communicated from the first specialist to the second specialist.

3. The system of claim 2, wherein the rules engine is further configured to apply customer information exchange business rules to determine the information related to the customer that is approved to be communicated based on at least one of (1) information related to the customer accessible to the first specialist, and (2) a type of the second specialist.

4. The system of claim 1, wherein the customer transferring module is further configured to (1) present the customer, via the video conferencing apparatus, an information exchange option and, in response to receiving a customer input that selects the information exchange option, (2) electronically communicate, to the second specialist, the information related to the customer.

5. The system of claim 1, wherein the customer transferring module is further configured present, in the transition mode, a dual screen display of a first video stream of the first specialist and a second video stream or an image of the second specialist.

6. The system of claim 1, wherein the customer transferring module is further configured to transition the video conference communication session between the customer and the first specialist to the transition mode, wherein the transition mode allows the customer, the first specialist and the second specialist to communicate using one or more media formats chosen from (1) audio, (2) video or (3) text chat.

7. The system of claim 1, wherein the customer transferring module is further configured to determine the one or more communication media for the customer to use to communicate with the second specialist based on at least one of (1) business rules, and (2) media capabilities of second specialist.

8. The system of claim 1, wherein the first specialist is associated with a first line-of-business and the second specialist is associated with a second line-of-business different from the first line-of-business.

9. A method for transferring a customer between specialists in a video conferencing environment utilized at a business location, the method comprising:
in response to receiving, during a video conference communication session conducted between a customer and a first specialist, an indication that the customer requires communication with a second specialist, electronically communicating, by a computing device processor, to the second specialist, information related to the customer; and
transitioning, by a computing device processor, the video conference communication session from communication between the customer and the first specialist to a transition mode that allows the customer, the first specialist and the second specialist to communicate simultaneously prior to the first specialist exiting the video conference communication session.

10. The method of claim 9, further comprising applying, by a computing device processor, business rules to determine the information related to the customer that is approved to be communicated from the first specialist to the second specialist.

11. The method of claim 10, wherein applying the business rules further comprises applying business rules to determine the information related to the customer that is approved to be communicated based on at least one of (1) information related to the customer accessible to the first specialist, and (2) a type of the second specialist.

12. The method of claim 9, further comprising:
presenting to the customer, by a computing device processor via a video conferencing apparatus, an information exchange option; and,
in response to receiving a customer input that selects the information exchange option, electronically communicating, to the second specialist, the information related to the customer.

13. The method of claim 9, wherein transitioning further comprises presenting, by a computing device processor, in the transition mode, a dual screen display of a first video stream of the first specialist and a second video stream or image of the second specialist.

14. The method of claim 9, wherein transitioning further comprises transitioning the video conference communication session from communication between the customer and the first specialist to a transition mode, wherein the transition mode allows the customer, the first specialist and the second specialist to communicate using one or more media formats chosen from (1) audio, (2) video or (3) text chat.

15. A computer program product comprising:
a non-transitory computer-readable medium comprising:
a first set of codes for causing a computer to, in response to receiving, during a video conference communication session conducted between a customer, located at a place of business, and a first specialist, an indication that the customer requires communication with a second specialist, electronically communicate, to the second specialist, information related to the customer; and
a second set of codes for causing a computer to seamlessly transition the video conference communication session from communication between the customer and the first specialist to a transition mode that allows the customer, the first specialist and the second specialist to communicate simultaneously prior to the first specialist exiting the video conference communication session.

16. The computer program product of claim 15, further comprising a third set of codes for causing a computer to apply business rules to determine the information related to the customer that is approved to be communicated from the first specialist to the second specialist.

17. The computer program product of claim 16, wherein the third set of codes is further configured to cause the computer to apply the business rules to determine the information related to the customer that is approved to be communicated based on at least one of (1) information related to the customer accessible to the first specialist and (2) a type of the second specialist.

18. The computer program product of claim 15, further comprising:
a third set of codes for causing a computer to present to the customer, via a video conference apparatus, an information exchange option,
wherein the first set of codes is further configured to cause the computer to, in response to receiving a customer input that selects the information exchange option, electronically communicate, to the second specialist, the information related to the customer.

19. The computer program product of claim 15, wherein the second set of codes is further configured to cause the computer to present, in the transition mode, a dual screen display of a first video stream of the first specialist and a second video stream or image of the second specialist.

20. The computer program product of claim 15, wherein the second set of codes is further configured to transition the video conference communication session from communication between the customer and the first specialist to a transition mode, wherein the transition mode allows the customer, the first specialist and the second specialist to communicate using one or more communication media chosen from (1) audio, (2) video or (3) text chat.
